(19) United States
(12) Patent Application Publication
(10) Pub. No.: US 2026/0119014 A1
(43) Pub. Date: Apr. 30, 2026

(54) NAVIGATING AN APPLICATION OBJECT GRAPH IN SPATIAL COMPUTING ENVIRONMENTS

(71) Applicant: SAP SE, Walldorf (DE)

(72) Inventors: Peter Eberlein, Malsch (DE); Volker Driesen, Heidelberg (DE)

(21) Appl. No.: 18/933,589

(22) Filed: Oct. 31, 2024

(51) Int. Cl. G06F 3/0484; G06F 9/451

(52) U.S. Cl. CPC G06F 3/0484; G06F 9/451

(57) ABSTRACT

A computer-implemented method includes identifying, using a spatial controller for application object graph (SCAOG) and a spatial computing system user interface (UI), an object type root node associated with a particular object type, where the object type root node has relations to all graph database object (GDO) instances in a graph database with a particular attribute and with a particular value. Fact sheets associated with the GDO instances with the particular attribute and with the particular value are displayed. A particular GDO instance is focused. Initially provided GDO types related to the particular object type are revised with revised GDO types of a particular relevance. The revised GDO types are focused. A graph traversal from the GDO type of revised GDO types to the GDO types related to the revised GDO types is executed. The revised GDO types are grouped based on results of the graph traversal.

### BACKGROUND

Applications for enterprises and large organizations typically use application objects of various types to structure content and methods for operating on the content. These application objects are connected to other objects (of the same or different types) using relations. Currently, such applications normally have a web-based user interface (UI), with individual screens to visualize application object content and to enable maintenance of application object content. The application enables navigation between application objects using the web-based UI (e.g., in a window) and either a new window (e.g., in a web browser) is opened for visualizing another application object, often (or at least partially) hiding the original window, or the other application object to show replaces the former application object within the original window. Relations between application objects are typically displayed as reference name or identifier (ID) in an attribute of the application object. However, this approach is optimized for use by applications on a laptop or desktop computer systems with limited computer display real estate (including more than one computer monitor) and interactions performed using either a pointing device/keyboard or a touch display.

### SUMMARY

The present disclosure describes navigating an application object graph in spatial computing environments.

In an implementation, a computer-implemented method for navigating an application object graph in spatial computing environments, comprises: identifying, using a spatial controller for application object graph (SCAOG) and a spatial computing system user interface (UI), an object type root node associated with a particular object type, wherein the object type root node has relations to all graph database object (GDO) instances in a graph database with a particular attribute and with a particular value; displaying, using the SCAOG and the spatial computing system UI, fact sheets associated with the GDO instances with the particular attribute and with the particular value; focusing, using the SCAOG and the spatial computing system UI, a particular GDO instance; revising, using the SCAOG and the spatial computing system UI and as revised GDO types, initially provided GDO types related to the particular object type with revised GDO types of a particular relevance; focusing, using the SCAOG and the spatial computing system UI, the revised GDO types; executing, using the SCAOG and the spatial computing UI, a graph traversal from the GDO type of revised GDO types to the GDO types related to the revised GDO types; and grouping, using the SCAOG and the spatial computing system UI, the revised GDO types based on results of the graph traversal.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, a described solution provides a spatial controller using an application object graph (AOG) and integrated with a number of applications can enable new intuitive and integrated workflows within a spatial computing environment spanning information managed in different applications using one consistent interface. Otherwise, several applications need to be integrated and navigation between the different applications need to be implemented with their own controller per object type. Second, the described solution provides generic navigation, filtering, and clustering based on the AOG with enhanced features. Third, the AOG permits execution of graph traversal finding objects related only using one or more intermediary objects. Queries are typically slow when executed in one relational database - requiring many joins on foreign key relationships can become cumbersome and custom implementations if the objects desired to be accessed are managed in different applications. The described approach is generic.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a block diagram of a computer-implemented system for navigating an application object graph in spatial computing environments, according to an implementation of the present disclosure.

FIG. 2 is a box diagram illustrating a sales agent seeking a custom record, according to an implementation of the present disclosure.

FIG. 3 is a box diagram illustrating a sales agent navigating to related orders of a customer in focus where there are many orders in a stack, according to an implementation of the present disclosure.

FIG. 4 is a box diagram illustrating a sales agent navigating to related orders of a customer in focus where there are many orders in a stack, but wishes to only continue to recent orders, according to an implementation of the present disclosure.

FIG. 5 is a box diagram illustrating a sales agent navigating to related orders of a customer in focus where there are many orders in a stack, but wishes to only continue to recent orders that are relatively expensive, according to an implementation of the present disclosure.

FIG. 6 is a box diagram illustrating a sales agent wishing to narrow results to just a few items, according to an implementation of the present disclosure.

FIG. 7 is a flowchart illustrating an example of a computer-implemented method for navigating an application object graph in spatial computing environments, according to an implementation of the present disclosure.

FIG. 8 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes navigating an application object graph in spatial computing environments and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Aspects of this disclosure are based on analogous elements of U.S. Pat. No. 11,354,302 B2 to Eberlein et al. (the “'302 patent”), titled “Automatic Creation and Synchronization of Graph Data Objects”. The '302 patent is hereby incorporated by reference in its entirety.

Applications for enterprises and large organizations typically use application objects of various types to structure content (more generically, data) and methods for operating on the data. These application objects are connected to other objects (of the same or different data types) using relations. Currently, such applications normally have a web-based user interface (UI), with individual screens to visualize application object data and to enable maintenance of application object data. The application enables navigation between application objects using the web-based UI (e.g., in a window) and either a new window (e.g., in a web browser) is opened for visualizing another application object, often (or at least partially) hiding the original window, or the other application object to show replaces the former application object within the original window. Relations between application objects are typically displayed as reference name or identifier (ID) in an attribute of the application object. However, this approach is optimized for use by applications on a laptop or desktop computer systems with limited physical computer display real estate (including more than one computer monitor) and interactions performed using either a pointing device/keyboard or a touch display.

New visualization and interaction technology (e.g., virtual reality (VR) and augmented reality (AR)) is being increasingly adopted and extends both visualization and interaction with different types of data. For example, new devices (e.g., META QUEST, APPLE VISION PRO, and MAGIC LEAP) extend visualization and interactions with data beyond the limits of physical computer displays to enable spatial visualization of applications and associated data in a virtual space that can fill the virtual space. Such devices also integrate gesture capture in a three-dimensional (3D) space for easier interaction and navigation in an application.

With a large language model (LLM)-based conversational interface, natural language (and voice) commands can be added to further improve interaction with the device/data. In some cases, output can be delivered using a synthetic voice. Digital assistants combined with voice-to-text translation functionality permit translation of user voice commands to commands sent to an application. Application output can be transformed into natural language text and then synthesized into naturally sounding speech for consumption by a user. The new visualization and interaction technology typically comes with a set of libraries, application programming interfaces (APIs) and programming paradigms to take advantage of the technology.

The described approach permits immersive applications to leverage these technologies for visualizing application objects and their relations which are organized in a graph-type structure. New ways of navigating application objects based on the relations can be introduced. A generic, standardized interface is provided, which exposes application objects and their relations in a fashion which conforms to a spatial computing environment more naturally than traditional database tables and browser-based UIs.

The described approach enables application objects to be visualized as fact sheets and for navigation between related application objects in a spatial computing environment, even when the application objects are managed in different backend applications or are only indirectly related. The approach operates on an application object and relation graph model, with the application objects and relations derived automatically from application data. A single consistent interface is exposed to navigate between application objects and relations and to retrieve related data within a UI component. Graph traversal can be used to visualize application objects related using many application objects and relations, to filter visualization of application object instances based on application object attributes, and to filter based on attributes in relations between application objects. Based on the graph, application objects can be clustered, relations between collections of application objects can be derived, and collections of application objects can be filtered based on relational attributes.

### Problem Description

Many applications (e.g., business-related applications) are associated with a lot of data, which is structured in many instances of many application object types having many attributes and with complex relations between application objects. Visualization of this type of data is difficult.

Application data is typically stored in many database tables and relational models and can be mapped to different application object types. Therefore, an application data set can be represented as a stack of many instances of many object types. While this approach permits structuring the data and for visualization, visualizing relations between data sets is typically limited to usage of identifiers and short text strings. Users wishing to visualize several full application objects within traditional window-based applications typically use many monitors during their work but still lack an efficient/useful visualization of relations.

Use of the significantly larger visual real estate provided by spatial computing can help solve this problem. Spatial computing enables concurrent display of many instances of full application objects next to each other, including relations between application object instances. Application object instances of the same type can be visualized as stacks of documents of the same type, therefore grouping application object instances and enabling visualizing relations between groups of application object instances. The question is how to best focus visualization on a manageable subset of many application object and relation instances.

Users typically do not need to access all instances of an application object type, but often enough they require access to more than one (a subset) application object instance at a particular time. Many application objects, typically related application object instances, should be visualized simultaneously, which allows for a good overview. Additionally, fast navigation to related, un-visualized application object instances is desirable.

A solution to this problem is to visualize application object instances of a same type as intelligently grouped stacks of application object instances with relations between application objects or stacks of application objects. Filtering on application object, relation types, and on application object instances can be enabled using defined application object instance attribute values or value ranges.

The described approach is based on an object and relation representation of application data (i.e., a graph with nodes and edges) and relations to other data sets. A cluster and filter approach is applied on application objects along several characteristics: 1) use object type and relation type for coarse grained clustering and filtering and 2) add attributes of other application object instances and relation instances for fine-grained filtering of application object instances within a cluster or relation instances between application objects. In some implementations, filtering can be enabled on clusters as well as on single instances of application objects.

Advanced graph techniques can be used to further reduce visible information to the desired subset: 1) A relation between two application object instances can be facilitated by intermediary object instances and relations between them (i.e., nodes and relations) and 2) paths of intermediary application object instances and relations can be collapsed to a derived direct relation, and visualization can be focused by only showing the derived direct relation. Derived relations can be constructed between clusters of application objects aggregating attributes of several application object relation instances.

The described approach requires application objects to be structured into an Application Object Graph (AOG) with properly managed application object relations as a foundation for the described visualizations and navigation.

From an application development perspective, a question exists as to the best way to apply visualization and navigation techniques of spatial computing libraries to several application objects, especially to objects being managed in different backend applications.

The described approach specifies to create a representation of the application objects with relations between application objects as a graph with nodes and edges. Graph algorithms and graph visualization/navigation techniques can be used.

Other interfaces to visualization and navigation techniques are possible, but the described approach focuses on re-use. Relations can also be derived for a spatial application from data directly—but likely code deriving relations is similar to the code used in an AOG implementation, however less generic. Using a graph representation of the data allows for use of generic UI patterns and libraries in implementing the extended user interface in spatial computing.

### Enabling Filtering and Search

The AOG possesses information about application object instances and relations between application object instances (typically of a different type), but, in addition, permits navigation between application objects of the same type and search in collections of application objects based on similarity.

The described approach adds an object-type root node to the AOG, and all application objects of this type are related to their root node. Both application objects and relations can possess attributes which permit search or filtering. Filtering can be computed by finding all application object instances related to a root node, where the attribute is of the desired value (range).

Natural Language Application object types and relations have names, the application object instances attributes with names and values can be typically represented as text, which permits use of natural language for clustering, filtering, and navigation. Intermediary terms introduced by the system (such as, “collection” or “cluster” of application objects) can be understood by a user and used intuitively in response for further interaction, especially if the term reflects what the user sees (or is visualized explicitly). If the described approach responds with “the selected application objects are grouped in cluster <name>,” a user will likely respond on the next command using the term “cluster” as well.

### Artificial Intelligence (AI)

Having a graph representation permits use of graph clustering approaches using algorithms and AI. Collections of application objects in a cluster can then form a foundation for further interaction with the user (e.g., filter and navigate). A use case can be application objects of the same type, clustering on application object attributes and on relations to other application objects.

For the purposes of this disclosure:
“Collection of objects” or “collection” is used for a number of objects of the same type, but a visualization is not decided.
When visualization is decided, there are two variants:
   A “set of objects” or “set of fact sheets” is used for a small number of items being displayed “side-by-side” without overlap, as there is enough space in a special computing environment to show all simultaneously with meaningful information.
   A “stack of objects” or “stack of fact sheets” is used for a large number of items being displayed “as a stack” with overlap, as there is not enough space to show all simultaneously.
The number of object threshold deciding when to switch between display methodologies can be configured or computed out of a remaining amount of visualization space.

### Approach and Procedure

The described approach uses an AOG created from application objects, which are managed in one or more applications. The application objects in the AOG are related to other application objects in the AOG, and even to application objects originating from other applications. The relations are derived from foreign key information in the application data. For application object representations in spatial computing environments, a fact sheet is used to visualize key information of an application object. For example, a fact sheet will typically contain an object type (e.g., “Sales Order”), an identifier or name (e.g., “ID 4711”) and key attributes with the attribute name and value (e.g., “customer=‘Smith’, “status=‘open’”), and if the AO has a “header item structure”, the number of related items (e.g., “nr of product=‘6’”). Or, more generically: important facts about an objects at a glance. For each object type it is defined as to what subset of all the data the object comprises should go into a fact sheet. For example, a summary of most important facts about the object.

The AOG is used as a source for a spatial controller for application object graph (SCOG), which can read application objects and relations from the AOG and execute a graph traversal. The Spatial controller facilitates data provisioning to a UI component managing the display of a spatial computing system, as well as receiving input (e.g., screen focus/object selection, input commands, and text) from the UI component and deriving actions to be performed. Such actions can be operations on the application object representation in the spatial controller, retrieving data from the AOG, or calling the AOG to perform actions (e.g., navigation, filtering, and clustering).

With this infrastructure and in a spatial computing environment, an application object can be requested to be visualized (e.g., using natural language), where the request is processed using the spatial controller and the application object is read from the AOG. From this first fact sheet, information can be visualized, which fact sheets are related can be communicated, and users can select one or more fact sheets and request their display. Indirect queries of a user can also be enabled, such as when a user queries to find application objects of a certain type related to an application object in focus.

Additionally, collection-operations can be enabled. A set of a few fact sheets can be displayed next to each other, allowing a user to browse through the set and filter for objects having certain attributes or relations. Related collections of fact sheets can be displayed and filtering on relation-attributes can be enabled to reduce a number of objects in two related sets.

In some implementations, some additional enabling techniques can include:
A type object as a common root object to navigate to all object instances of its type (e.g., used to search for desired object instances of a certain type).
Filtered navigation along graph relations to reduce a result set when navigating 1: n relations. Especially for header item relations with many items or to reduce navigation options of objects with a large number of related other objects.
Clustering of graph data objects with parameters, number of clusters, and clustering criteria (typically an attribute on the objects themselves or on the relations to these objects) and using machine learning (ML) to produce a desired number of clusters according to a given criteria when navigating 1: n relations to the objects.
Enable graph navigation and operations on collections of graph data objects and relations (compared to individual object instances), including derived relations with intermediary graph data objects.
Collecting attributes on relations or intermediary objects when navigating collections of graph data objects. This enables filtering and clustering of graph data objects based on attributes that are not attached to the graph data objects directly but can be found in the relation path towards them.

This enables navigating the AOG in spatial computing environments to realize scenarios, where a user needs information from related objects to solve a current task, but objects are only related using intermediary objects (in a relational database this would be records related using several foreign key relationship definitions) or when the objects have a large number of related information.

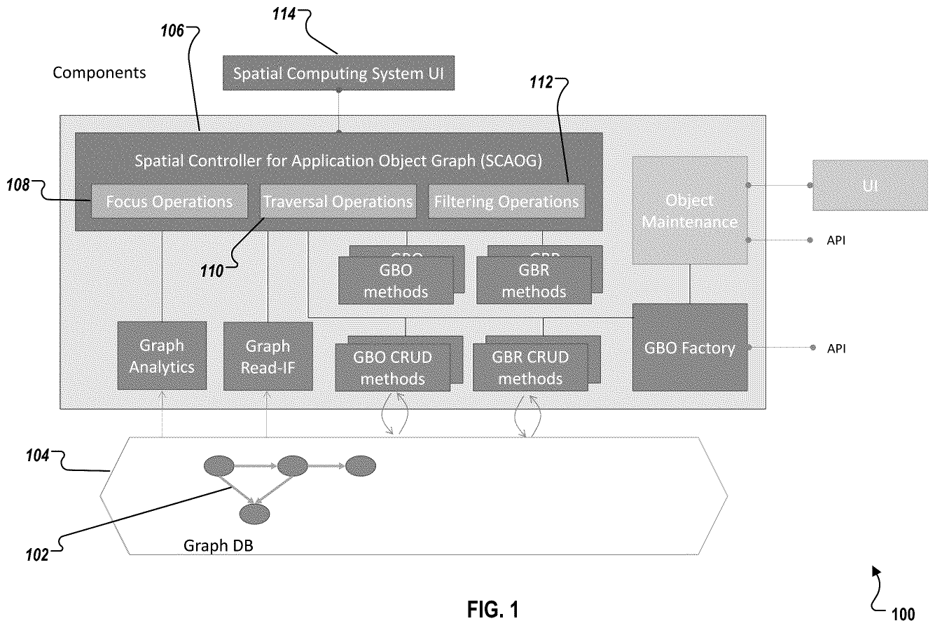

FIG. 1 is a block diagram of a computer-implemented system 100 for navigating an application object graph in spatial computing environments, according to an implementation of the present disclosure.

In some implementations, an AOG 102 within a graph DB 104 can:
Create graph data objects (GDO) read from application objects in an integrated application,
Create graph data relations (GDR) to connect two GDOs, the data read from the foreign key relationship between application objects in one or two integrated applications (a GDR can relate objects created from two applications being integrated with the AOG),
Relate each GDO of the same type to a root GDO for this type, so all GDOs of the same type are organized for efficient collection operations on GDOs of the same type,
Update GDOs and GDRs upon changes of the data in the application, so the representation in the AOG is up to date,
Traverse the graph, starting from one GDO, finding another GDO connected with one or several GDR(s), iteratively, until the desired GDO is found,
Create a new derived GDR out of a collection of GDR—GDO—GDR (iteratively adding more GDOs—GDRs) to create direct relations between GDOs which are in the initial graph only related via a longer path.

In some implementations:
GDOs and GDRs are of a certain type,
GDOs and GDRs have an identifier and attributes, the identifier and subset of attributes should have a text representation which can be used in natural language communication,
GDOs of the same type are related to a root GDO of the type, where the type has a natural language name,
GDOs have a fact sheet (or generate a fact sheet upon need, e.g., summarizing GDO and its attributes using generative AI),

In some implementations, a spatial controller for application object graph (SCAOG) (or spatial controller) 106, can:
Retrieve objects (GDO) and relations (GDR) from AOG, and store an own representation of these allowing to add attributes and methods, § Query the AOG for graph traversal: specify one GDO—follow a relation to another GDO and so on,
Call AOG to create a “derived GDR” and relate GDOs with this “derived GDR,”
Be notified upon changes to a GDO or GDR.

In some implementations, spatial control 106 focus operations 108, traversal operations 110, and filtering operations 112:
Focus operations 108 on single objects:
   Display a fact sheet and attributes.
Traversal operations 110 on single objects:
   Display relations to other objects,
   Select other objects being related to the single object using a direct relation, specified by relation name,
   or using a graph traversal, specifying a target object type or identifier,
   Other objects can be a single object or a collection of objects.
Focus Operations 108 on a collection of objects (of the same type):
   Browse through the collection of objects to visualize and put a single object in focus,
   Visualize attributes of the objects or relations to the objects for filtering and search. When a user specifies attribute value, range, regular expression, etc., the collection of objects is reduced to a subset, where the objects have attributes of the matching values,
Traversal Operations 110 on collections of objects:
   Display relations to other object types,
   Select other objects being related to one or more objects in the collection of objects using a direct relation, specified by relation name,
   or using a graph traversal, specifying the target object type,
   The other objects can be a single object or a collection of objects.
Filtering Operations 112 on two or more collections of objects:
   Display relation type(s) and relation attributes,
   When a user specifies attribute value, range, regular expression, etc., the objects in the two or more collections of objects are reduced to a subset, where the objects are related by relations having attributes of matching values.

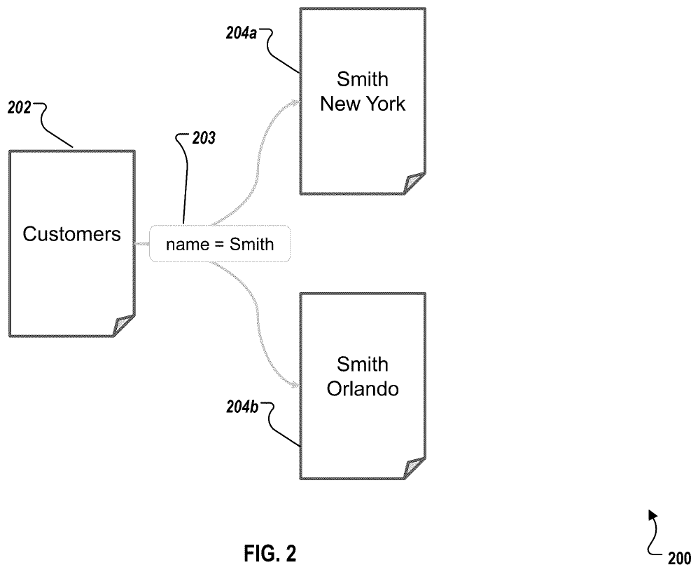

In some implementations, a spatial computing system UI 114 is provided to generate GUI visualizations for navigating an AOG in spatial computing environments. The spatial computing system UI 114 can generate displays for various spatial computing environments, consistent with available functionality, parameters, and limitations. FIGS. 2-6 provide some simplistic example representations of a possible UI to help understanding. However, the examples provided are not intended to limit in any way possible UI functionality that can be provided by the spatial computing system UI 114 to generate GUI visualizations at least for navigating an AOG in spatial computing environments.

FIG. 2 is a box diagram 200 illustrating a sales agent seeking a custom record, according to an implementation of the present disclosure. A sales agent receives a customer complaint about prices that are too high. The idea is to offer a quantity discount on relatively expensive items that have been recently ordered in higher quantities. For the example, the idea is not yet fully worked out as the sales agent starts interacting with the system but develops the idea as related application objects are brought up into a spatial computing space step-by-step.

### Step 1

A sales agent needs to find a customer record. Starting with generic customer objects 202, a filter is added for the customer's name. Unfortunately, there are two customers of this name 204a and 204b, but in different cities (i.e., New York and Orlando, respectively). As it is only two results, they can be both be displayed next to each other and the sales agent can select and simply continue with the correct one.

In the provided example, the user asks to display a “customer with name ‘Smith’” (203), the SCAOG 106 identifies an object type root node with name customer and receives type CustomerRoot. This object has relations to all GDO instances of type Customer. The GDOs with attribute “name” equal to “Smith” are selected. For these instances, fact sheets are provided and can be displayed using the spatial computing system UI 114. The benefit of working with an object type root object is that filtering and navigation is the same as between object instances.

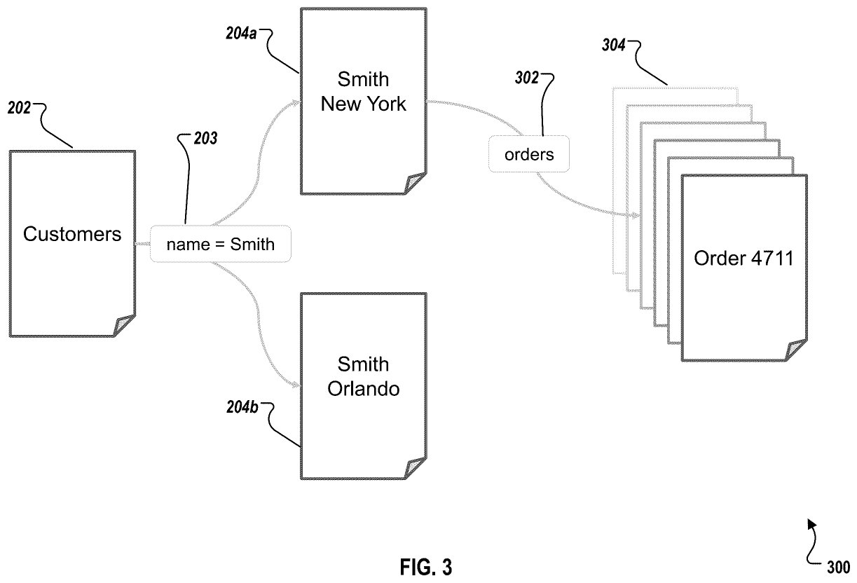

FIG. 3 is a box diagram 300 illustrating a sales agent navigating to related orders of a customer in focus where there are many orders in a stack, according to an implementation of the present disclosure.

### Step 2

A sales agent navigates to related orders of a customer in focus. As there are so many, they are displayed in a stack on the spatial computing system UI 114.

In the provided example, the user puts object Customer with attribute name “Smith” in focus. The SCAOG 106 provides GDO types related to GDO type “Customer”, which can be used to visualize navigation options. For Customer, type Order (302) is provided. The user can initiate visualizing fact sheets (304) of type Order, related to object Customer with attribute name “Smith.” The result set is rather large, so a “stack of fact sheets” is visualized using the spatial computing system UI 114.

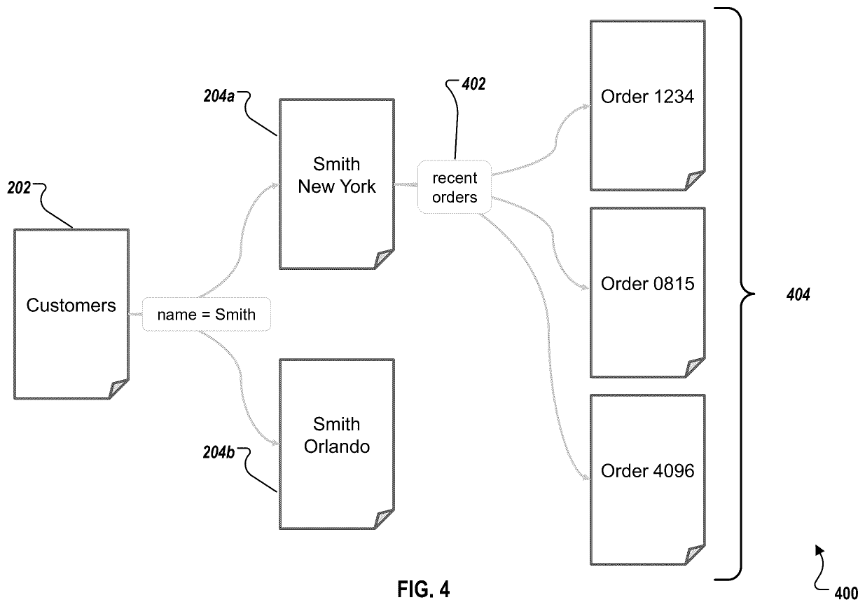

FIG. 4 is a box diagram 400 illustrating a sales agent navigating to related orders of a customer in focus where there are many orders in a stack, but wishes to only continue to recent orders, according to an implementation of the present disclosure.

### Step 3

In the provided example, the sales agent wants to continue only with recent orders as they are more relevant. In some implementations, a definition of “recent” could be configured or determined by a ML algorithm clustering all orders along a timeline. Replacing the request for “orders” by a request for “recent orders,” 402 only three orders 404 (fact sheets) remain and can be displayed next to each other in some orientation (e.g., vertical as shown in FIG. 4).

The user puts the stack of orders 404 in focus. SCAOG 106 provides (together with the object types related to Order) filtering options (attributes of the object type, i.e., “ID.” “date,” “status,” . . ., etc.) for object types of Order. The user could filter by providing criteria for the attributes (e.g., “status”=“open”), but also indirect criteria. An indirect criteria can also be formulated in natural language.

The request is translated to a selection on the object attributes using, for example, configured parameters or an AI assistant. For example, the user specifies “display recent orders only. ” For an AI assistant, the used LLM can be provided with the object attributes of the objects in the stack together with the request (mapping “display” to “select” operation) “select IDs of recent orders only.” An LLM can then provide IDs of instances of Order with “recent date.”

In the example, only three objects are filtered out. Since the number of fact sheets is below a threshold derived from space in the visualization, the visualization can be changed from stack of objects (e.g., 302 from FIG. 3) to a set of objects 404 and displayed in a side-by-side manner using the spatial computing system UI 114.

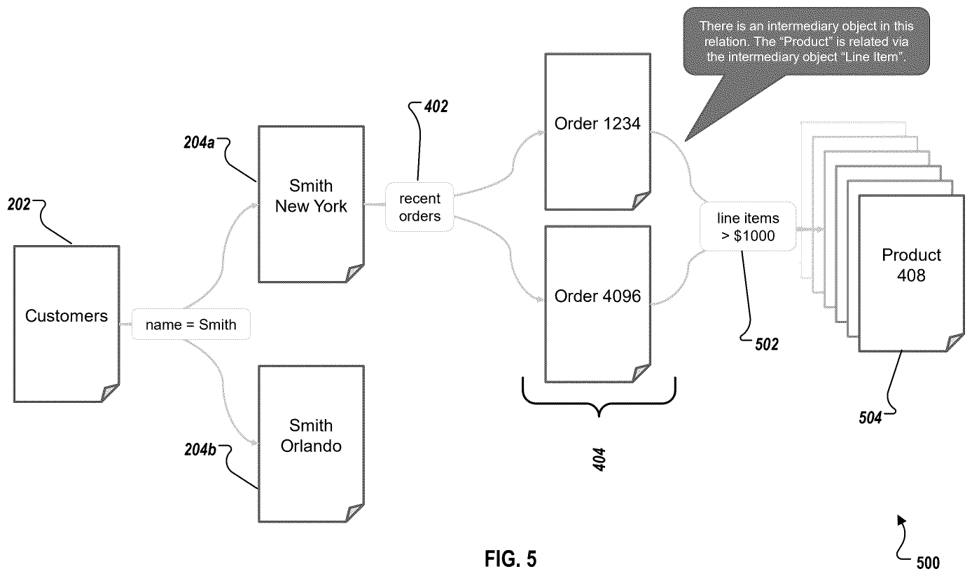

FIG. 5 is a box diagram 500 illustrating a sales agent navigating to related orders of a customer in focus where there are many orders in a stack, but wishes to only continue to recent orders that are relatively expensive, according to an implementation of the present disclosure.

### Step 4

A sales agent now wants to see all items of the displayed orders that are relatively expensive, so a quantity discount has a tangible effect. The sales agent therefore navigates to all products contained in the displayed orders 404 that have a price of more than $1000 (502). Unfortunately, there are many items matching this criteria, so they are displayed in a stack 504. Note that order 0815 (refer to FIG. 4) is removed from the display as this order does not contain any line item with a price >$1000.

The user puts the set of Order objects (504) in focus. SCAOG 106 provides the object types related to Order for navigation, in this case Line-Item. The user ignores listed navigation options and requests, “show related products.” An assistant reads object types related to Order and does not find object type Product. The assistant calls SCAOG 106 to run a graph traversal from object type Order to type Product. SCAOG 106 finds a relation using intermediary object type Line-Item: the set “Order—relation to—Line-Item—relation to—Product” can define a new direct relation between Order and Product. This new GDR can be enriched with attributes from Line-Item, e.g., product_quantity. SCAOG 106 can be called to create new direct relations, R_op, between Order and Product. Alternatively, example queries use the set “Order—relation to—Line-Item—relation to—Product.”

The assistant triggers the SCAOG 106 to find instances of type Product related to “Order 1234” (using the relation R_op), then “Order 0815,” and finally “Order 4086” and receives three result sets of product instances. Since a “set of Order objects” is in focus, the results are merged and shown as a related stack 504 to the three objects in focus. This is a new capability enabled by the SCAOG 106 that permits operations on collections of objects, merging the results of these operations, instead of applying the operation only to one object at a time.

The user details (=filters) ” ith price higher than $1000” (502). The assistant filters the instances of Product for attribute “price” higher than $1000. Of the three result sets, now the second result set related to “Order 0815” (refer to FIG. 4) is empty. This information can be used on the UI to undisplay instance “Order 0815” (refer to FIG. 4). The resulting stack (504) of fact sheets is visualized using the spatial computing system UI 114.

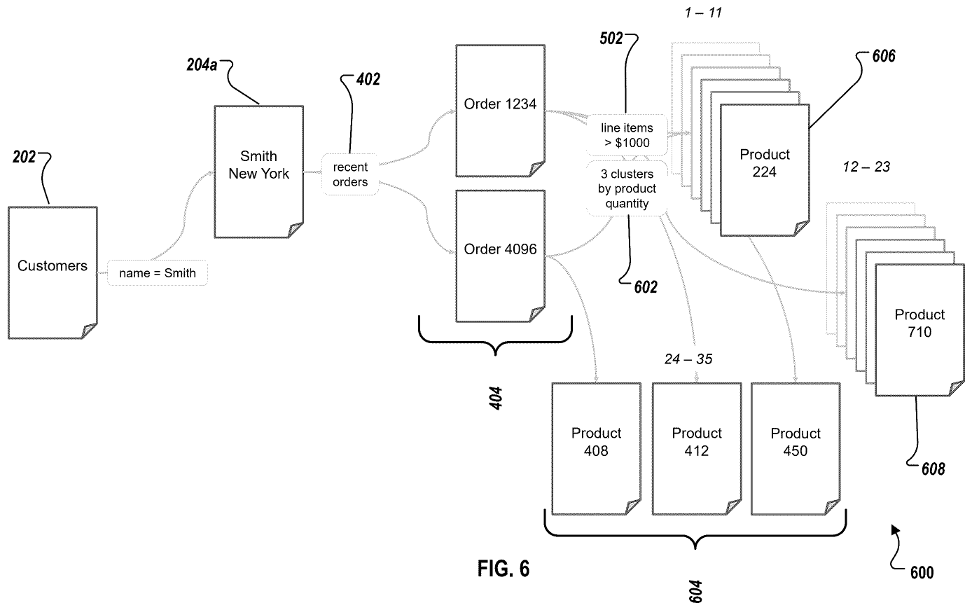

FIG. 6 is a box diagram 600 illustrating a sales agent wishing to narrow results to just a few items, according to an implementation of the present disclosure.

### Step 5

A sales agent finally wants to get down to just a few items to look at closely. For this, a clustering request 602 is added to the already filtered relation (line item >$1000 502) between orders and products. Sales agent wants to group products into three buckets according to the order quantity, to group products that have been ordered below average, on average, and more than average. The exact thresholds between these groups can be determined by a ML algorithm (clustering functionality). Interestingly, there are only three products (604) in the group with above average product quantity between 24-35, product 408 that was ordered in order 4096 and products 412 and 450 that were ordered in order 1234. The sales agent can now inspect these three products more closely and decide which one(s) should be proposed to the customer for a better quantity discount.

For this, the user puts the (remaining two) sets of Order objects 404 in focus. The user asks to “group orders along product quantity into three groups. ” To compute this grouping, operations are required with two collections of objects: “Orders” and “Products.” The following would of course also work, if one has one collection of objects and a single instance of an object, but being able to operate on multiple collections.

For the grouping, the attribute product_quantity of the derived relation R_op (see step 4) between each instance of Order in the first collection to an instance of Product in the second collection is summed. Thus, for every instance of Product, one gets a “sum of product_quantities.” This virtual attribute “sum of product_quantities” can then be used for grouping. The algorithm can determine a minimum and maximum value, and compute the value ranges for the groups using a similar range size. An alternative can be to create groups with a similar object instance count.

The groups of instances of Product can then be used to display three stacks of fact sheets (604, 606, and 608). If a stack is very small (e.g., 604 in the example has three objects), the fact sheets can also be displayed as a set of fact sheets. The other two stacks of fact sheets (606 and 608) are displayed as stacks given their number. Having drilled down to a small number of Products, the sales agent can inspect each item and determine one(s) with best option(s) for proposing a quantity discount to the customer.

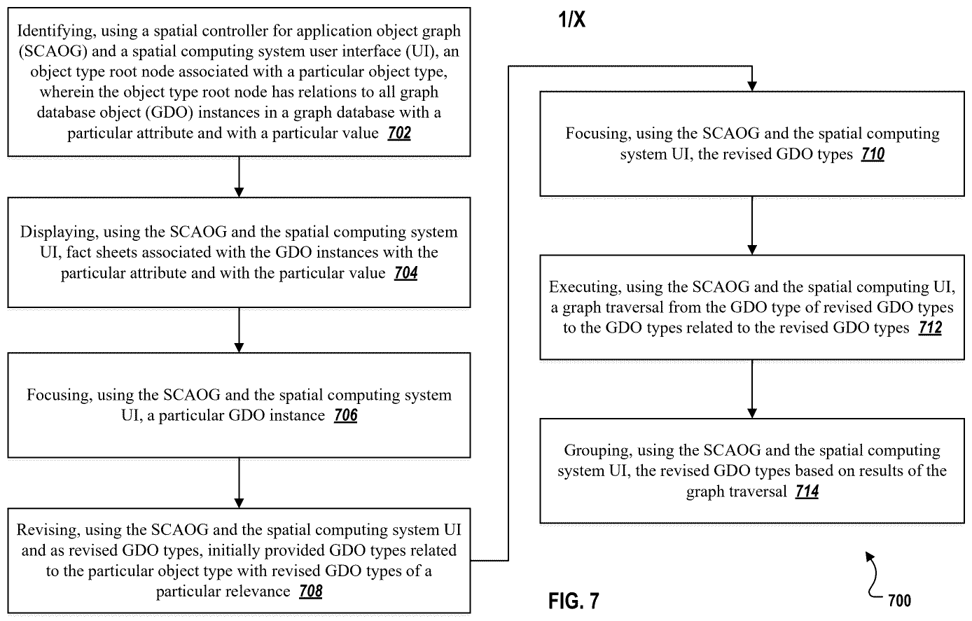

FIG. 7 is a flowchart illustrating an example of a computer-implemented method 700 for navigating an application object graph in spatial computing environments, according to an implementation of the present disclosure. For clarity of presentation, the description that follows generally describes method 700 in the context of the other figures in this description. However, it will be understood that method 700 can be performed, for example, by any system, environment, software, and hardware, or a combination of systems, environments, software, and hardware, as appropriate. In some implementations, various steps of method 700 can be run in parallel, in combination, in loops, or in any order.

At 702, using a spatial controller for application object graph (SCAOG) and a spatial computing system user interface (UI), an object type root node associated with a particular object type is identified, where the object type root node has relations to all graph database object (GDO) instances in a graph database with a particular attribute and with a particular value.

Before the identifying and using the SCAOG, filtering for the particular object type, the particular attribute, and the particular value from generic data objects, where the filtering is provided by filtering operations, and where the filtering operations can: 1) display relation type(s) and relation attributes and 2) reduce two or more collections of objects to a subset, where the two or more collections of objects are related by relations having attributes of matching values. GDO instances are selected using the SCAOG and the spatial computing system UI. From 702, method 700 proceeds to 704.

At 704, using the SCAOG and the spatial computing system UI, fact sheets associated with the GDO instances with the particular attribute and with the particular value are displayed. From 704, method 700 proceeds to 706.

At 706, using the SCAOG and the spatial computing system UI, a particular GDO instance is focused upon. GDO types related to the particular object type are provided. Using the SCAOG and the spatial computing system UI, fact sheets of a type matching the GDO types related to the particular object type and related to the particular attribute are initiated, where the fact sheets of a type matching the GDO types related to the particular object type and related to the particular attribute are numerous and are arranged in a stack using the spatial computing system UI. From 706, method 700 proceeds to 708.

At 708, using the SCAOG and the spatial computing system UI and as revised GDO types, initially provided GDO types related to the particular object type are revised with revised GDO types of a particular relevance. In some implementations, the revised GDO types of a particular relevance are selected by an artificial intelligence (AI) engine and the revised GDO types are displayed on the spatial computing system UI in an orientation different than the fact sheets of a type matching the GDO types related to the particular object type and related to the particular attribute. From 708, method 700 proceeds to 710.

At 710, using the SCAOG and the spatial computing system UI, focusing on revised GDO types. Using the SCAOG and the spatial computing system UI, GDO types related to the revised GDO types are provided. In some implementations, the executing determines relations. From 710, method 700 proceeds to 712.

At 712, using the SCAOG and the spatial computing UI, a graph traversal is executed from the GDO type of revised GDO types to the GDO types related to the revised GDO types. From 712, method 700 proceeds to 714.

At 714, using the SCAOG and the spatial computing system UI, the revised GDO types are grouped based on results of the graph traversal. After 714, method 700 can stop.

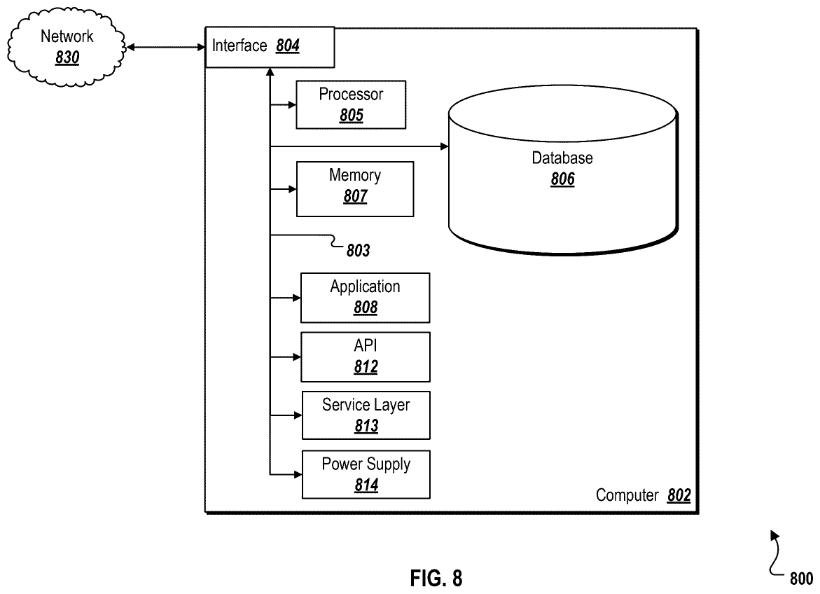

FIG. 8 is a block diagram illustrating an example of a computer-implemented System 800 used to provide computational functionalities associated with described algorithms, methods, functions, processes, flows, and procedures, according to an implementation of the present disclosure. In the illustrated implementation, computer-implemented system 800 includes a Computer 802 and a Network 830.

The illustrated Computer 802 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 802 can include an input device, such as a keypad, keyboard, or touch screen, or a combination of input devices that can accept user information, and an output device that conveys information associated with the operation of the Computer 802, including digital data, visual, audio, another type of information, or a combination of types of information, on a graphical-type user interface (UI) (or GUI) or other UI.

The Computer 802 can serve in a role in a distributed computing system as, for example, a client, network component, a server, or a database or another persistency, or a combination of roles for performing the subject matter described in the present disclosure. The illustrated Computer 802 is communicably coupled with a Network 830. In some implementations, one or more components of the Computer 802 can be configured to operate within an environment, or a combination of environments, including cloud-computing, local, or global.

At a high level, the Computer 802 is an electronic computing device operable to receive, transmit, process, store, or manage data and information associated with the described subject matter. According to some implementations, the Computer 802 can also include or be communicably coupled with a server, such as an application server, e-mail server, web server, caching server, or streaming data server, or a combination of servers.

The Computer 802 can receive requests over Network 830 (for example, from a client software application executing on another Computer 802) and respond to the received requests by processing the received requests using a software application or a combination of software applications. In addition, requests can also be sent to the Computer 802 from internal users (for example, from a command console or by another internal access method), external or third-parties, or other entities, individuals, systems, or computers.

Each of the components of the Computer 802 can communicate using a System Bus 803. In some implementations, any, or all of the components of the Computer 802, including hardware, software, or a combination of hardware and software, can interface over the System Bus 803 using an application programming interface (API) 812, a Service Layer 813, or a combination of the API 812 and Service Layer 813. The API 812 can include specifications for routines, data structures, and object classes. The API 812 can be either computer-language independent or dependent and refer to a complete interface, a single function, or even a set of APIs. The Service Layer 813 provides software services to the Computer 802 or other components (whether illustrated or not) that are communicably coupled to the Computer 802. The functionality of the Computer 802 can be accessible for all service consumers using the Service Layer 813. Software services, such as those provided by the Service Layer 813, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 802, alternative implementations can illustrate the API 812 or the Service Layer 813 as stand-alone components in relation to other components of the Computer 802 or other components (whether illustrated or not) that are communicably coupled to the Computer 802. Moreover, any or all parts of the API 812 or the Service Layer 813 can be implemented as a child or a sub-module of another software module, enterprise application, or hardware module without departing from the scope of the present disclosure.

The Computer 802 includes an Interface 804. Although illustrated as a single Interface 804, two or more Interfaces 804 can be used according to particular needs, desires, or particular implementations of the Computer 802. The Interface 804 is used by the Computer 802 for communicating with another computing system (whether illustrated or not) that is communicatively linked to the Network 830 in a distributed environment. Generally, the Interface 804 is operable to communicate with the Network 830 and includes logic encoded in software, hardware, or a combination of software and hardware. More specifically, the Interface 804 can include software supporting one or more communication protocols associated with communications such that the Network 830 or hardware of Interface 804 is operable to communicate physical signals within and outside of the illustrated Computer 802.

The Computer 802 includes a Processor 805. Although illustrated as a single Processor 805, two or more Processors 805 can be used according to particular needs, desires, or particular implementations of the Computer 802. Generally, the Processor 805 executes instructions and manipulates data to perform the operations of the Computer 802 and any algorithms, methods, functions, processes, flows, and procedures as described in the present disclosure.

The Computer 802 also includes a Database 806 that can hold data for the Computer 802, another component communicatively linked to the Network 830 (whether illustrated or not), or a combination of the Computer 802 and another component. For example, Database 806 can be an in-memory or conventional database storing data consistent with the present disclosure. In some implementations, Database 806 can be a combination of two or more different database types (for example, a hybrid in-memory and conventional database) according to particular needs, desires, or particular implementations of the Computer 802 and the described functionality. Although illustrated as a single Database 806, two or more databases of similar or differing types can be used according to particular needs, desires, or particular implementations of the Computer 802 and the described functionality. While Database 806 is illustrated as an integral component of the Computer 802, in alternative implementations, Database 806 can be external to the Computer 802. The Database 806 can hold and operate on at least any data type mentioned or any data type consistent with this disclosure.

The Computer 802 also includes a Memory 807 that can hold data for the Computer 802, another component or components communicatively linked to the Network 830 (whether illustrated or not), or a combination of the Computer 802 and another component. Memory 807 can store any data consistent with the present disclosure. In some implementations, Memory 807 can be a combination of two or more different types of memory (for example, a combination of semiconductor and magnetic storage) according to particular needs, desires, or particular implementations of the Computer 802 and the described functionality. Although illustrated as a single Memory 807, two or more Memories 807 or similar or differing types can be used according to particular needs, desires, or particular implementations of the Computer 802 and the described functionality. While Memory 807 is illustrated as an integral component of the Computer 802, in alternative implementations, Memory 807 can be external to the Computer 802.

The Application 808 is an algorithmic software engine providing functionality according to particular needs, desires, or particular implementations of the Computer 802, particularly with respect to functionality described in the present disclosure. For example, Application 808 can serve as one or more components, modules, or applications. Further, although illustrated as a single Application 808, the Application 808 can be implemented as multiple Applications 808 on the Computer 802. In addition, although illustrated as integral to the Computer 802, in alternative implementations, the Application 808 can be external to the Computer 802.

The Computer 802 can also include a Power Supply 814. The Power Supply 814 can include a rechargeable or non-rechargeable battery that can be configured to be either user- or non-user-replaceable. In some implementations, the Power Supply 814 can include power-conversion or management circuits (including recharging, standby, or another power management functionality). In some implementations, the Power Supply 814 can include a power plug to allow the Computer 802 to be plugged into a wall socket or another power source to, for example, power the Computer 802 or recharge a rechargeable battery.

There can be any number of Computers 802 associated with, or external to, a computer system containing Computer 802, each Computer 802 communicating over Network 830. Further, the term “client,” “user,” or other appropriate terminology can be used interchangeably, as appropriate, without departing from the scope of the present disclosure. Moreover, the present disclosure contemplates that many users can use one Computer 802, or that one user can use multiple computers 802.

Described implementations of the subject matter can include one or more features, alone or in combination.

For example, in a first implementation, a computer-implemented method for navigating an application object graph in spatial computing environments, comprising: identifying, using a spatial controller for application object graph (SCAOG) and a spatial computing system user interface (UI), an object type root node associated with a particular object type, wherein the object type root node has relations to all graph database object (GDO) instances in a graph database with a particular attribute and with a particular value; displaying, using the SCAOG and the spatial computing system UI, fact sheets associated with the GDO instances with the particular attribute and with the particular value; focusing, using the SCAOG and the spatial computing system UI, a particular GDO instance; revising, using the SCAOG and the spatial computing system UI and as revised GDO types, initially provided GDO types related to the particular object type with revised GDO types of a particular relevance; focusing, using the SCAOG and the spatial computing system UI, the revised GDO types; executing, using the SCAOG and the spatial computing UI, a graph traversal from the GDO type of revised GDO types to the GDO types related to the revised GDO types; and grouping, using the SCAOG and the spatial computing system UI, the revised GDO types based on results of the graph traversal.

The foregoing and other described implementations can each, optionally, include one or more of the following features:

A first feature, combinable with any of the following features, comprising: before the identifying, filtering, using the SCAOG, for the particular object type, the particular attribute, and the particular value from generic data objects, wherein the filtering is provided by filtering operations, and wherein the filtering operations can: 1) display relation type(s) and relation attributes and 2) reduce two or more collections of objects to a subset, wherein the two or more collections of objects are related by relations having attributes of matching values.

A second feature, combinable with any of the previous or following features, comprising: selecting, using the SCAOG and the spatial computing system UI, the GDO instances.

A third feature, combinable with any of the previous or following features, comprising: providing, using the SCAOG, GDO types related to the particular object type; and initiating, using the SCAOG and the spatial computing system UI, fact sheets of a type matching the GDO types related to the particular object type and related to the particular attribute, wherein the fact sheets of a type matching the GDO types related to the particular object type and related to the particular attribute are numerous and are arranged in a stack using the spatial computing system UI.

A fourth feature, combinable with any of the previous or following features, wherein the revised GDO types of a particular relevance are selected by an artificial intelligence (AI) engine, and wherein the revised GDO types are displayed on the spatial computing system UI in an orientation different than the fact sheets of a type matching the GDO types related to the particular object type and related to the particular attribute.

A fifth feature, combinable with any of the previous or following features, comprising: providing, using the SCAOG and the spatial computing system UI, GDO types related to the revised GDO types.

A sixth feature, combinable with any of the previous or following features, wherein executing, using the SCAOG and the spatial computing UI, a graph traversal from the GDO type of revised GDO types to the GDO types related to the revised GDO types determines relations.

In a second implementation, a non-transitory, computer-readable medium storing one or more instructions executable by a computer system to perform one or more operations for navigating an application object graph in spatial computing environments, comprising: identifying, using a spatial controller for application object graph (SCAOG) and a spatial computing system user interface (UI), an object type root node associated with a particular object type, wherein the object type root node has relations to all graph database object (GDO) instances in a graph database with a particular attribute and with a particular value; displaying, using the SCAOG and the spatial computing system UI, fact sheets associated with the GDO instances with the particular attribute and with the particular value; focusing, using the SCAOG and the spatial computing system UI, a particular GDO instance; revising, using the SCAOG and the spatial computing system UI and as revised GDO types, initially provided GDO types related to the particular object type with revised GDO types of a particular relevance; focusing, using the SCAOG and the spatial computing system UI, the revised GDO types; executing, using the SCAOG and the spatial computing UI, a graph traversal from the GDO type of revised GDO types to the GDO types related to the revised GDO types; and grouping, using the SCAOG and the spatial computing system UI, the revised GDO types based on results of the graph traversal.

The foregoing and other described implementations can each, optionally, include one or more of the following features:

A first feature, combinable with any of the following features, comprising: before the identifying, filtering, using the SCAOG, for the particular object type, the particular attribute, and the particular value from generic data objects, wherein the filtering is provided by filtering operations, and wherein the filtering operations can: 1) display relation type(s) and relation attributes and 2) reduce two or more collections of objects to a subset, wherein the two or more collections of objects are related by relations having attributes of matching values.

A second feature, combinable with any of the previous or following features, comprising: selecting, using the SCAOG and the spatial computing system UI, the GDO instances.

A third feature, combinable with any of the previous or following features, comprising: providing, using the SCAOG, GDO types related to the particular object type; and initiating, using the SCAOG and the spatial computing system UI, fact sheets of a type matching the GDO types related to the particular object type and related to the particular attribute, wherein the fact sheets of a type matching the GDO types related to the particular object type and related to the particular attribute are numerous and are arranged in a stack using the spatial computing system UI.

A fourth feature, combinable with any of the previous or following features, wherein the revised GDO types of a particular relevance are selected by an artificial intelligence (AI) engine, and wherein the revised GDO types are displayed on the spatial computing system UI in an orientation different than the fact sheets of a type matching the GDO types related to the particular object type and related to the particular attribute.

A fifth feature, combinable with any of the previous or following features, comprising: providing, using the SCAOG and the spatial computing system UI, GDO types related to the revised GDO types.

A sixth feature, combinable with any of the previous or following features, wherein executing, using the SCAOG and the spatial computing UI, a graph traversal from the GDO type of revised GDO types to the GDO types related to the revised GDO types determines relations.

In a third implementation, a computer-implemented system for navigating an application object graph in spatial computing environments, comprising: one or more computers; and one or more computer memory devices interoperably coupled with the one or more computers and having tangible, non-transitory, machine-readable media storing one or more instructions that, when executed by the one or more computers, perform one or more operations, comprising: identifying, using a spatial controller for application object graph (SCAOG) and a spatial computing system user interface (UI), an object type root node associated with a particular object type, wherein the object type root node has relations to all graph database object (GDO) instances in a graph database with a particular attribute and with a particular value; displaying, using the SCAOG and the spatial computing system UI, fact sheets associated with the GDO instances with the particular attribute and with the particular value; focusing, using the SCAOG and the spatial computing system UI, a particular GDO instance; revising, using the SCAOG and the spatial computing system UI and as revised GDO types, initially provided GDO types related to the particular object type with revised GDO types of a particular relevance; focusing, using the SCAOG and the spatial computing system UI, the revised GDO types; executing, using the SCAOG and the spatial computing UI, a graph traversal from the GDO type of revised GDO types to the GDO types related to the revised GDO types; and grouping, using the SCAOG and the spatial computing system UI, the revised GDO types based on results of the graph traversal.

The foregoing and other described implementations can each, optionally, include one or more of the following features:

A first feature, combinable with any of the following features, comprising: before the identifying, filtering, using the SCAOG, for the particular object type, the particular attribute, and the particular value from generic data objects, wherein the filtering is provided by filtering operations, and wherein the filtering operations can: 1) display relation type(s) and relation attributes and 2) reduce two or more collections of objects to a subset, wherein the two or more collections of objects are related by relations having attributes of matching values.

A second feature, combinable with any of the previous or following features, comprising: selecting, using the SCAOG and the spatial computing system UI, the GDO instances.

A third feature, combinable with any of the previous or following features, comprising: providing, using the SCAOG, GDO types related to the particular object type; and initiating, using the SCAOG and the spatial computing system UI, fact sheets of a type matching the GDO types related to the particular object type and related to the particular attribute, wherein the fact sheets of a type matching the GDO types related to the particular object type and related to the particular attribute are numerous and are arranged in a stack using the spatial computing system UI.

A fourth feature, combinable with any of the previous or following features, wherein the revised GDO types of a particular relevance are selected by an artificial intelligence (AI) engine, and wherein the revised GDO types are displayed on the spatial computing system UI in an orientation different than the fact sheets of a type matching the GDO types related to the particular object type and related to the particular attribute.

A fifth feature, combinable with any of the previous or following features, comprising: providing, using the SCAOG and the spatial computing system UI, GDO types related to the revised GDO types.

A sixth feature, combinable with any of the previous or following features, wherein executing, using the SCAOG and the spatial computing UI, a graph traversal from the GDO type of revised GDO types to the GDO types related to the revised GDO types determines relations.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware-or software-based (or a combination of both hardware-and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security/access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method for navigating an application object graph in spatial computing environments, comprising:
identifying, using a spatial controller for application object graph (SCAOG) and a spatial computing system user interface (UI), an object type root node associated with a particular object type, wherein the object type root node has relations to all graph database object (GDO) instances in a graph database with a particular attribute and with a particular value;
displaying, using the SCAOG and the spatial computing system UI, fact sheets associated with the GDO instances with the particular attribute and with the particular value;
focusing, using the SCAOG and the spatial computing system UI, a particular GDO instance;
revising, using the SCAOG and the spatial computing system UI and as revised GDO types, initially provided GDO types related to the particular object type with revised GDO types of a particular relevance;
focusing, using the SCAOG and the spatial computing system UI, the revised GDO types;
executing, using the SCAOG and the spatial computing UI, a graph traversal from the GDO type of revised GDO types to the GDO types related to the revised GDO types; and
grouping, using the SCAOG and the spatial computing system UI, the revised GDO types based on results of the graph traversal.

2. The computer-implemented method of claim 1, comprising:
before the identifying, filtering, using the SCAOG, for the particular object type, the particular attribute, and the particular value from generic data objects, wherein the filtering is provided by filtering operations, and wherein the filtering operations can: 1) display relation type(s) and relation attributes and 2) reduce two or more collections of objects to a subset, wherein the two or more collections of objects are related by relations having attributes of matching values.

3. The computer-implemented method of claim 1, comprising:
selecting, using the SCAOG and the spatial computing system UI, the GDO instances.

4. The computer-implemented method of claim 1, comprising:
providing, using the SCAOG, GDO types related to the particular object type; and
initiating, using the SCAOG and the spatial computing system UI, fact sheets of a type matching the GDO types related to the particular object type and related to the particular attribute, wherein the fact sheets of a type matching the GDO types related to the particular object type and related to the particular attribute are numerous and are arranged in a stack using the spatial computing system UI.

5. The computer-implemented method of claim 1, wherein the revised GDO types of a particular relevance are selected by an artificial intelligence (AI) engine, and wherein the revised GDO types are displayed on the spatial computing system UI in an orientation different than the fact sheets of a type matching the GDO types related to the particular object type and related to the particular attribute.

6. The computer-implemented method of claim 1, comprising:
providing, using the SCAOG and the spatial computing system UI, GDO types related to the revised GDO types.

7. The computer-implemented method of claim 1, wherein executing, using the SCAOG and the spatial computing UI, a graph traversal from the GDO type of revised GDO types to the GDO types related to the revised GDO types determines relations.

8. A non-transitory, computer-readable medium storing one or more instructions executable by a computer system to perform one or more operations for navigating an application object graph in spatial computing environments, comprising:
identifying, using a spatial controller for application object graph (SCAOG) and a spatial computing system user interface (UI), an object type root node associated with a particular object type, wherein the object type root node has relations to all graph database object (GDO) instances in a graph database with a particular attribute and with a particular value;
displaying, using the SCAOG and the spatial computing system UI, fact sheets associated with the GDO instances with the particular attribute and with the particular value;
focusing, using the SCAOG and the spatial computing system UI, a particular GDO instance;
revising, using the SCAOG and the spatial computing system UI and as revised GDO types, initially provided GDO types related to the particular object type with revised GDO types of a particular relevance;
focusing, using the SCAOG and the spatial computing system UI, the revised GDO types;
executing, using the SCAOG and the spatial computing UI, a graph traversal from the GDO type of revised GDO types to the GDO types related to the revised GDO types; and
grouping, using the SCAOG and the spatial computing system UI, the revised GDO types based on results of the graph traversal.

9. The non-transitory, computer-readable medium of claim 8, comprising:
before the identifying, filtering, using the SCAOG, for the particular object type, the particular attribute, and the particular value from generic data objects, wherein the filtering is provided by filtering operations, and wherein the filtering operations can: 1) display relation type(s) and relation attributes and 2) reduce two or more collections of objects to a subset, wherein the two or more collections of objects are related by relations having attributes of matching values.

10. The non-transitory, computer-readable medium of claim 8, comprising:
selecting, using the SCAOG and the spatial computing system UI, the GDO instances.

11. The non-transitory, computer-readable medium of claim 8, comprising:
providing, using the SCAOG, GDO types related to the particular object type; and
initiating, using the SCAOG and the spatial computing system UI, fact sheets of a type matching the GDO types related to the particular object type and related to the particular attribute, wherein the fact sheets of a type matching the GDO types related to the particular object type and related to the particular attribute are numerous and are arranged in a stack using the spatial computing system UI.

12. The non-transitory, computer-readable medium of claim 8, wherein the revised GDO types of a particular relevance are selected by an artificial intelligence (AI) engine, and wherein the revised GDO types are displayed on the spatial computing system UI in an orientation different than the fact sheets of a type matching the GDO types related to the particular object type and related to the particular attribute.

13. The non-transitory, computer-readable medium of claim 8, comprising:
providing, using the SCAOG and the spatial computing system UI, GDO types related to the revised GDO types.

14. The non-transitory, computer-readable medium of claim 8, wherein executing, using the SCAOG and the spatial computing UI, a graph traversal from the GDO type of revised GDO types to the GDO types related to the revised GDO types determines relations.

15. A computer-implemented system for navigating an application object graph in spatial computing environments, comprising:
one or more computers; and
one or more computer memory devices interoperably coupled with the one or more computers and having tangible, non-transitory, machine-readable media storing one or more instructions that, when executed by the one or more computers, perform one or more operations, comprising:
identifying, using a spatial controller for application object graph (SCAOG) and a spatial computing system user interface (UI), an object type root node associated with a particular object type, wherein the object type root node has relations to all graph database object (GDO) instances in a graph database with a particular attribute and with a particular value;
displaying, using the SCAOG and the spatial computing system UI, fact sheets associated with the GDO instances with the particular attribute and with the particular value;
focusing, using the SCAOG and the spatial computing system UI, a particular GDO instance;
revising, using the SCAOG and the spatial computing system UI and as revised GDO types, initially provided GDO types related to the particular object type with revised GDO types of a particular relevance;
focusing, using the SCAOG and the spatial computing system UI, the revised GDO types;
executing, using the SCAOG and the spatial computing UI, a graph traversal from the GDO type of revised GDO types to the GDO types related to the revised GDO types; and
grouping, using the SCAOG and the spatial computing system UI, the revised GDO types based on results of the graph traversal.

16. The computer-implemented system of claim 15, comprising:
before the identifying, filtering, using the SCAOG, for the particular object type, the particular attribute, and the particular value from generic data objects, wherein the filtering is provided by filtering operations, and wherein the filtering operations can: 1) display relation type(s) and relation attributes and 2) reduce two or more collections of objects to a subset, wherein the two or more collections of objects are related by relations having attributes of matching values.

17. The computer-implemented system of claim 15, comprising:
selecting, using the SCAOG and the spatial computing system UI, the GDO instances.

18. The computer-implemented system of claim 15, comprising:
providing, using the SCAOG, GDO types related to the particular object type; and
initiating, using the SCAOG and the spatial computing system UI, fact sheets of a type matching the GDO types related to the particular object type and related to the particular attribute, wherein the fact sheets of a type matching the GDO types related to the particular object type and related to the particular attribute are numerous and are arranged in a stack using the spatial computing system UI.

19. The computer-implemented system of claim 15, wherein the revised GDO types of a particular relevance are selected by an artificial intelligence (AI) engine, and wherein the revised GDO types are displayed on the spatial computing system UI in an orientation different than the fact sheets of a type matching the GDO types related to the particular object type and related to the particular attribute.

20. The computer-implemented system of claim 15, comprising:
providing, using the SCAOG and the spatial computing system UI, GDO types related to the revised GDO types.

21. The computer-implemented system of claim 15, wherein executing, using the SCAOG and the spatial computing UI, a graph traversal from the GDO type of revised GDO types to the GDO types related to the revised GDO types determines relations.
